(19) United States
(12) Patent Application Publication
(10) Pub. No.: US 2007/0085801 A1
(43) Pub. Date: Apr. 19, 2007

(54) Flat panel display and method of driving the same

(75) Inventors: Woo-Il Park, Yongin-si (KR); Dae-Seop Kim, Anseong-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/440,338

(22) Filed: May 23, 2006

(30) Foreign Application Priority Data
Oct. 18, 2005 (KR) 2005-98210

(51) Int. Cl. G09G 3/36

(52) U.S. Cl. 345/98

(57) ABSTRACT

In a flat panel display, a display panel has a data line, a gate line and a pixel electrically connected to the data line and the gate line, and a timing controller outputs control signals and an image data signal. A data driver drives the data line in response to a portion of the control signals and the image data signal, and a gate driver drives the gate line in response to a different portion of the control signals. A control circuit controls the data driver such that the data line is maintained in a reset state for a predetermined time after a power-on is initiated. Thus, the flat panel display may prevent the display of the error-images on the liquid crystal panel.

### CROSS-REFERENCE TO RELATED APPLICATION

This application relies for priority upon Korean Patent Application No. 2005-98210 filed on Oct. 18, 2005, the contents of which are herein incorporated by reference in their entirety.

### BACKGROUND OF THE INVENTION

1. Field of the Invention

The present invention relates to a flat panel display. More particularly, the present invention relates to a flat panel display having improved display quality and a method of driving the same.

2. Description of the Related Art

Recently, flat panel displays have become widely available. Because of their advantages, which include light weight, significantly reduced thickness, etc., flat panel displays are widely employed as user interfaces for to electronic devices. In accordance with the type of panel on which an image is displayed, flat panel displays are classified as organic light emitting diode (OLED) displays, liquid crystal displays (LCDs), field emission displays (FEDs), vacuum fluorescent displays (VFD), plasma display panels (PDPs), or the like.

A liquid crystal display panel included in an LCD includes a plurality of pixels configured in a matrix, where the pixels include thin film transistors that operate as switching devices. Each of the pixels selectively receives a data voltage corresponding to an image signal through the thin film transistor. The LCD also includes a gate driver that applies a gate-on voltage to gate lines, a data driver that applies the image signal to data lines and a control circuit that controls the gate driver and the data driver.

The gate lines provide a gate-on voltage turning on the thin film transistor or a gate-off voltage turning off the thin film transistor. For example, when power is turned on, a direct current-to-direct current (DC/DC) converter outputs the gate-off voltage of about −13 volts. However, a predetermined time interval is necessary until the gate-off voltage becomes stable at about −13 volts. Before the gate-off voltage becomes sufficiently stable at about −13 volts, the thin film transistor is maintained in a slightly turned-on state until the gate-off voltage reaches a voltage of about −6 volts. As a result, the data lines have a random voltage level, so that error-images corresponding to the random voltage level of the data lines are displayed on the liquid crystal display panel of the LCD. Error-images as described above are continuously displayed on the display panel for about 60 milliseconds until an effective pixel data signal is outputted from the control circuit.

Error-images may be prominently displayed when the data lines electrically connected to certain integrated circuits among a plurality of integrated circuits for the data driver are driven in response to data signals having specific voltage levels equal to each other while the power is turned on.

Therefore, current systems generally do not to allow the data lines to have the specific voltage levels until the gate-off voltage is sufficiently stable after the power is turned on.

### SUMMARY OF THE INVENTION

The present invention provides a flat panel display having an improved display quality.

The present invention also provides a method suitable for manufacturing the above flat panel display.

In one aspect of the present invention, a flat panel display includes a timing controller, a data driver and a control circuit. The timing controller outputs an image data signal, and the data driver drives a data line in response to a control signal and the image data signal. The control circuit generates the control signal such that the data line is maintained in a reset state for a predetermined time after a power-on state is initiated.

The timing controller further outputs a line latch signal to indicate a drive timing of the data line by the data driver.

The control circuit receives an external power voltage and the line latch signal. The control signal has a same waveform as that of the line latch signal after the predetermined time has elapsed.

The control circuit further includes a delay circuit delaying an external power voltage, a pulse generator receiving the external power voltage and the delayed external power voltage from the delay circuit to generate a pulse signal, and a logic circuit outputting the control signal based on the line latch signal and the pulse signal.

The flat panel display further includes a gate driver to drive a gate line in communication with one or more transistors. The control circuit generates the control signal such that the data line is maintained in a reset state until the gate driver drives the gate line using a sufficient gate-off voltage subsequent to the initiation of the power-on state.

In another aspect of the present invention, a flat panel display includes a timing controller, a data driver and a control circuit. The timing controller outputs a first line latch signal and an image data signal. The data driver drives a data line in response to a second line latch signal and the image data signal. The control circuit receives an external power voltage and the first line latch signal and generates the second line latch signal such that the data line is maintained in a reset state for a predetermined time subsequent to initiation of a power-on state of the display.

The control circuit further includes a delay circuit, a pulse generator and a logic circuit. The delay circuit delays an external power voltage. The pulse generator receives the external power voltage and the delayed external power voltage from the delay circuit to generate a pulse signal. The logic circuit outputs the second line latch signal based on the first line latch signal and the pulse signal.

The data driver includes a latch circuit latching the image data signal from the timing controller in response to the second line latch signal, and an output driving circuit receiving the image data signal from the latch circuit and driving the data line in response to the second line latch signal.

The control circuit outputs the second line latch signal such that an output of the latch circuit is maintained in the reset state for the predetermined time subsequent to initiation of a power-on state.

In still another aspect of the present invention, a flat panel display includes a display panel, a timing controller, a data driver, a gate driver and a control circuit. The display panel has a data line, a gate line and a pixel electrically connected to the data line and the gate line. The timing controller outputs control signals and an image data signal. The data driver drives the data line in response to a portion of the control signals and the image data signal. The gate driver drives the gate line in response to a different portion of the control signals. The control circuit controls the data driver to allow the data line not to be driven with the image data signal for a predetermined time subsequent to initiation of a power-on state.

The control signals from the timing controller include a first line latch signal indicative of timing to apply the image data signal to the data line.

The control circuit outputs a second line latch signal to control the data driver.

The control circuit outputs a second line latch signal having a predetermined level for the predetermined time subsequent to the initiation of the power-on state.

The control circuit outputs a first line latch signal from the timing controller as the second line latch signal after the power is turned on and the predetermined time has elapsed.

The control circuit includes a delay circuit, a pulse generator and a logic circuit. The delay circuit delays an external power voltage. The pulse generator receives the external power voltage and the delayed external power voltage by the delay circuit to generate a pulse signal. The logic circuit receives the pulse signal from the pulse generator and the first line latch signal from the timing controller to output the second line latch signal.

The control circuit includes a first resistor, a capacitor, a second resistor, a transistor, a first diode and a second diode. The first resistor has a first terminal to which the external power voltage is applied. The capacitor is electrically connected between a second terminal of the first resistor and a ground. The second resistor has a first terminal to which the external power voltage is applied. The transistor has a gate electrically connected to the second terminal of the first resistor and a current path electrically connected between a second terminal of the second resistor and the ground. The first diode has an input terminal electrically connected to the second terminal of the second resistor and an output terminal. The second diode has an input terminal to which the first line latch signal from the timing controller is applied and an output terminal. The output terminals of the first and second diodes are commonly connected to each other, and the second line latch signal is output from the output terminals of the first and second diodes.

The data driver includes a shift register, a data register, a latch, a digital-to-analog converter and an output buffer. The shift register shifts a clock signal in response to a horizontal start signal. The data register stores the image data signal from the timing controller in response to the clock signal from the shift register. The latch latches the stored image data signal in the data register in response to the second line latch signal from the control circuit. The digital-to-analog converter converts the image data signal from the latch into an analog image signal. The output buffer outputs the analog image signal from the digital-to-analog converter to the data line in response to the first line latch signal.

In further still another aspect of the present invention, a method of driving a flat panel display having a data driver driving a data line in response to an image data signal is provided as follows. When a power for the flat panel display is turned on, the data driver is reset for a predetermined time. The predetermined time is a time period equal to or greater than a time to drive the gate line to a sufficient gate-off voltage.

In further still another aspect of the present invention, a method of driving a flat panel display having a data driver driving a data line in response to an image data signal is provided as follows.

When a power voltage is applied to the data driver, the power voltage is delayed. Responsive to the power voltage and the delayed power voltage, a pulse signal is generated, and the data line is reset for a time equal to the width of the pulse signal. The pulse signal is a line latch signal.

According to the above, the line latch signal that controls the latch circuit in the data driving circuit is set at the high level before the data driving voltages are applied to the data driving circuit and subsequent to initiation of a power-on state. Thus, although the data driving voltages are applied to the data driving circuit, the data driving signals are not output from the latch circuit.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing a liquid crystal display as an example of a type of flat panel display, according to an exemplary embodiment of the present invention;

FIG. 2 is a block diagram showing an embodiment of a data driving circuit that may be used with the display of FIG. 1 in detail;

FIG. 3 is a block diagram showing an embodiment of a control circuit that may be used with the display of FIG. 1;

FIG. 4 is timing diagrams of signals for the control circuit shown in FIG. 3;

FIG. 5 is a view showing a relation between a gate-off voltage and a second line latch signal; and

FIG. 6 is a circuit diagram showing a control circuit according to another exemplary embodiment of the present invention.

### DESCRIPTION OF THE EMBODIMENTS

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure. The presence of an element described as “first” does not imply the need for a “second” or other element.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “comprises,” “comprising,” “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

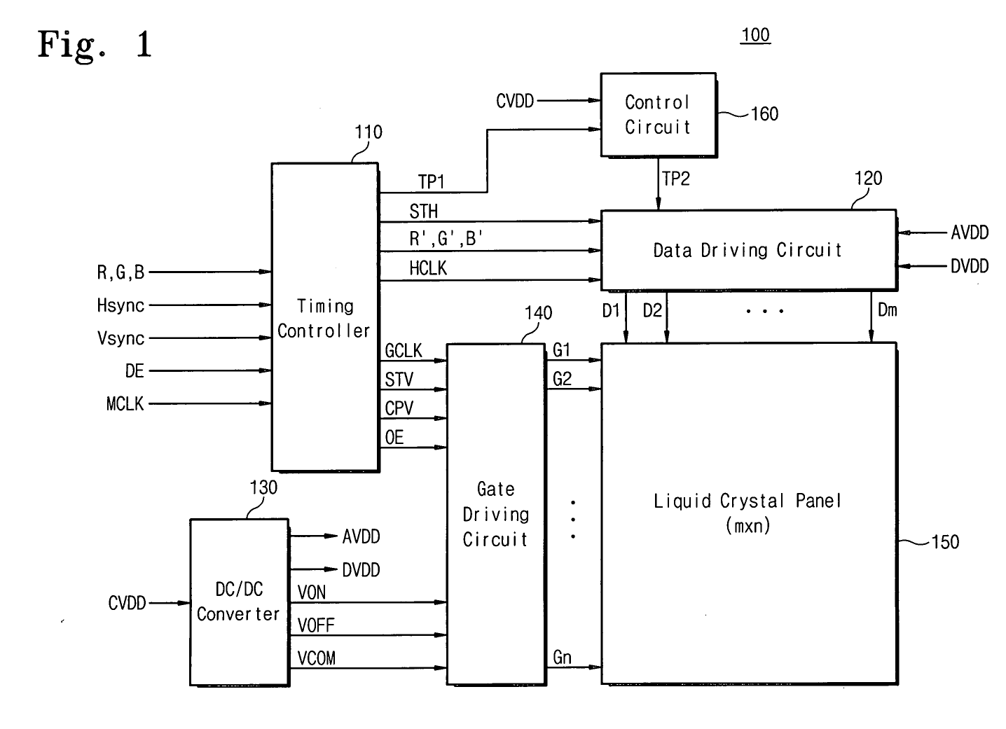

FIG. 1 is a block diagram a liquid crystal display 100, which is one type of flat panel display, according to an exemplary embodiment of the present invention.

Referring to FIG. 1, a liquid crystal display 100 includes a timing controller 110, a data driving circuit 120, a direct current to direct current (DC/DC) converter 130, a gate driving circuit 140, a liquid crystal panel 150 and a control circuit 160.

The liquid crystal panel 150 includes a plurality of gate lines G1-Gn, a plurality of data lines D1-Dm crossing the gate lines G1-Gn to form a plurality of pixel areas, and a plurality of pixels formed in the pixel areas, respectively. The pixels are arranged in a matrix configuration. Each of the pixels includes a thin film transistor, a liquid crystal capacitor (not shown) and a storage capacitor (not shown).

The thin film transistor includes a gate electrode electrically connected to the gate line, a data electrode electrically connected to the data line and a drain electrode electrically connected to the liquid crystal capacitor. When the gate lines G1-Gn are sequentially selected by the gate driving circuit 140 and a gate-on voltage VON is applied to the selected gate lines in a pulse shape, the thin film transistors connected to the selected gate lines are turned on and the data driving circuit 120 applies a voltage having pixel information to the associated data lines (a voltage corresponding to the desired image part for the associated pixel). The voltage having the pixel information is applied to the liquid crystal capacitor and the storage capacitor through the thin film transistors that are turned on by the gate-on voltage VON. As a result, the liquid crystal capacitor and the storage capacitor are charged, and display a predetermined image part on the liquid crystal panel 150.

The timing controller 110 receives a vertical synchronization signal Vsync, a horizontal synchronization signal Hsync, a data enable signal DE, a clock signal MCLK and pixel data RGB from an external graphic source. The timing controller 110 outputs a pixel data signal R′, G′, B′ for the liquid crystal panel 150 after formatting the pixel data RGB. The timing controller 110 also applies a horizontal start signal STH and a clock signal HLCK to the data driving circuit 120, and applies a first line latch signal TP1 to the control circuit 160.

Further, the timing controller 110 applies a vertical start signal STV, a gate clock signal CPV and an output enable signal OE to the gate driving circuit 140 in response to the horizontal synchronization signal Hsync, the vertical synchronization signal Vsync, and the data enable signal DE.

The control circuit 160 receives an external power voltage CVDD and the first line latch signal TP1 from the timing controller 110 to output a second line latch signal TP2.

Responsive to the second line latch signal TP2 and the pixel data signal R′, G′, B′, the horizontal start signal STH and the clock signal HCLK from the timing controller 110, the data driving circuit 120 outputs signals to drive the data lines D1-Dm. In some embodiments, the data driving circuit 120 is configured to have a plurality of integrated circuits.

The gate driving circuit 140 sequentially scans the gate lines G1-Gn of the liquid crystal panel 150 in response to the signals applied from the timing controller 110. Here, the scanning operation of the gate driving circuit 140 means that the gate driving circuit 140 sequentially applies a gate-on voltage to the gate lines, such that the pixels connected to the gate lines to which the gate-on voltage is applied are in a data writable state. For example, for a pixel comprising a liquid crystal capacitor, application of a sufficient gate-on voltage to its associated gate line results in electrical communication between the associated data line voltage (corresponding to the desired image part for the pixel) and the liquid crystal capacitor.

The DC/DC converter 130 generates data driving voltages DVDD and AVDD, the gate-on voltage VON, the gate-off voltage VOFF, and a common electrode voltage VCOM used to drive the liquid crystal display 100 in response to the external power voltage CVDD.

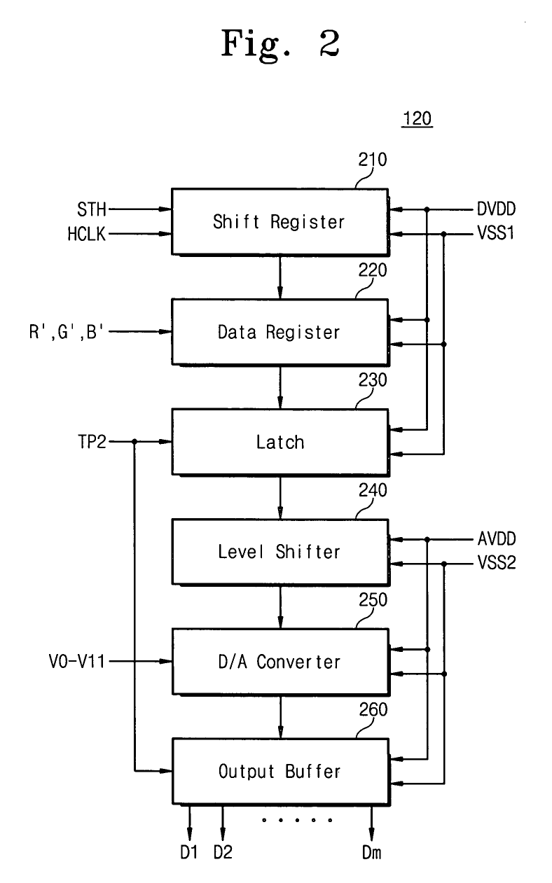

FIG. 2 is a block diagram showing an embodiment of the data driving circuit 120 of FIG. 1 in detail.

Referring to FIG. 2, the data driving circuit 120 includes a shift register 210 generating a sampling signal, a data register 220 storing the pixel data R′ G′ B′ therein in response to the sampling signal, a latch 230 latching the pixel data R′ G′ B′ provided from the data register 220, a level shifter 240 increasing an amplitude of the pixel data from the latch 230, a digital-to-analog (D/A) converter 250 converting the pixel data outputted from the level shifter 240 into an analog signal, and an output buffer 260.

The shift register 210 sequentially shifts the horizontal start signal STH from the timing controller 110 in response to the clock signal HCLK to output the shifted horizontal start signal as the sampling signal.

The data register 220 samples the pixel data R′ G′ B′ from the timing controller 110 in response to the sampling signal from the shift register 210 and stores the sampled pixel data R′ G′ B′ therein. The data register 220 has a size corresponding to a value obtained by multiplying a number of pixels in a horizontal direction by a number of bits of respective pixel data. The latch 230 latches the pixel data R′ G′ B′ from the data register 220 and outputs the latched pixel data R′ G′ B′ in response to the second line latch signal TP2 from the control circuit 160.

The level shifter 240 performs a level shifting operation to increase a voltage swing width of the pixel data R′ G′ B′ outputted from the latch 230. The D/A converter 250 converts the pixel data from the level shifter 240 into the analog pixel data signal with gray-scale voltages V0-V11. The output buffer 260 stores the analog pixel data signal outputted from the D/A converter 250 and provides the data lines D1-Dm with the stored analog pixel data signal in response to the second line latch signal TP2 of the liquid crystal panel 150. For example, the latch 230 outputs the pixel data R′ G′ B′ from the data register 220 to the level shifter 240 at a rising edge of the second line latch signal TP2, and the output buffer 260 provides the analog pixel data signal from the D/A converter 250 to the data lines D1-Dm at a falling edge of the second line latch signal TP2.

When application of the data driving voltage DVDD to the data driving circuit 120 is initiated after the power is turned on, the shift register 210, the data register 220 and the latch 230 are driven, but the latch 230 is maintained in an indeterminate state before the second line latch signal TP2 is input. When the data driving voltage AVDD from the DC/DC converter 130 is applied to the data driving circuit 120, the pixel data signal output from the latch 230 is applied to the data lines D1-Dm via the level shifter 240, the D/A converter 250 and the output buffer 260. Before the gate-off voltage VOFF is lowered to a level sufficient to turn off the thin film transistor, the thin film transistor is maintained in a slightly turned-on state. As a result, the pixel data signal applied to the data lines D1-Dm is transmitted to the liquid crystal capacitor through the thin film transistor, thereby displaying an error-image on the liquid crystal panel 150.

In order to prevent the error-image from being displayed on the liquid crystal panel 150, the control circuit 160 outputs the second line latch signal TP2 at a high level to reset an output of the latch 230 at least until the gate-off voltage is lowered to the level sufficient to turn off the thin film transistor after the power is turned on. Thus, the data driving circuit 120 may be maintained in a reset state while the second line latch signal TP2 is maintained at the high level.

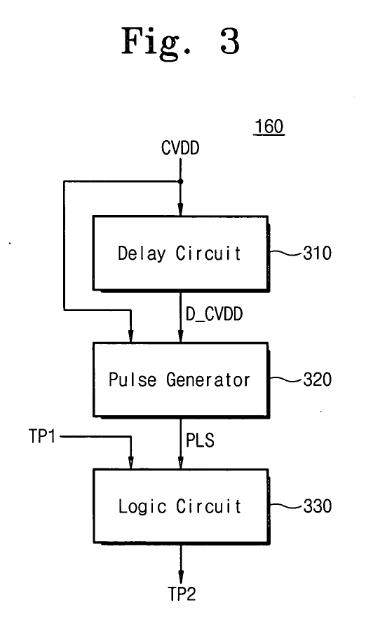

FIG. 3 is a block diagram showing the control circuit of FIG. 1.

Referring to FIG. 3, the control circuit 160 includes a delay circuit 310, a pulse generator 320 and a logic circuit 330. The delay circuit 310 delays the external power voltage CVDD for a predetermined time to output a signal D_CVDD. The pulse generator 320 receives the signal D_CVDD and the external power voltage CVDD and outputs a pulse signal PLS. The logic circuit 330 receives the first line latch signal TP1 from the timing controller 110 and the pulse signal PLS from the pulse generator 320 to output the second line latch signal TP2. In the exemplary embodiment of the present invention, the logic circuit 330 may be a logic operation circuit (which may comprise one or more logic gates); for example, logic circuit 330 may comprise a logic-OR operation circuit.

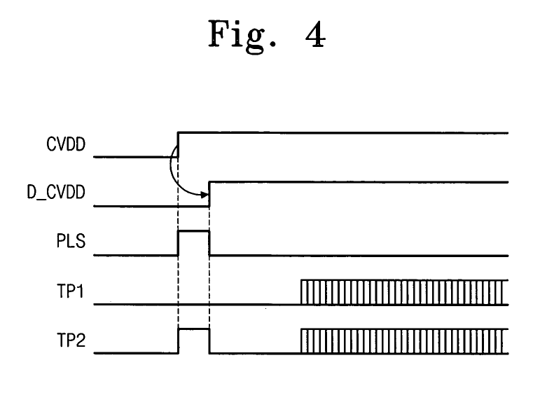

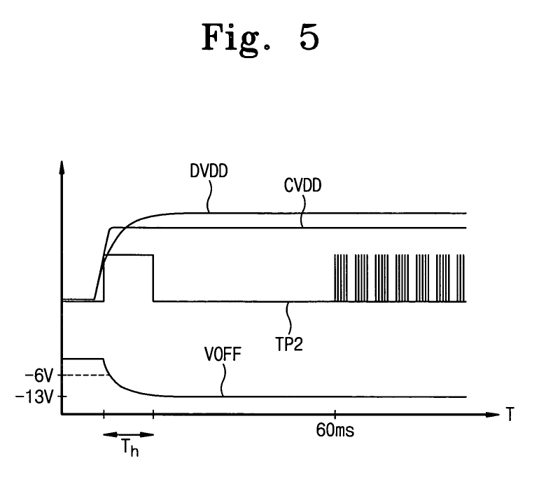

FIG. 4 is timing diagram of signals for the embodiment of control circuit 160 shown in FIG. 3. FIG. 5 is a view showing a relation between the gate-off voltage VOFF and the second line latch signal TP2.

Referring to FIGS. 4 and 5, the second line latch signal TP2 is maintained at the high level for the predetermined time Tₕ after the external power voltage CVDD is applied to the liquid crystal display 100. A high level period Tₕ of the second line latch signal TP2 corresponds a delay time of the delay circuit 310 and is substantially same time that elapses before the gate-off voltage VOFF is lowered to a level sufficient to turn off the thin film transistor. In some embodiments, the high level period Th of the second line latch signal TP2 is about 5 milliseconds or more.

Since the second line latch signal TP2 is set at the high level before the data driving voltages DVDD and AVDD are applied to the data driving circuit 120, the outputs of the latch 230 and the output buffer 260 shown in FIG. 2 are reset before the data driving voltages DVDD and AVDD are applied to the data driving circuit 120. Thus, the data lines D1-Dm are not driven until the gate-off signal is lowered to the level sufficient to turn off the thin film transistor, thereby preventing the display of the error-image on the liquid crystal panel 150 when the liquid crystal display 100 is turned on. As shown in FIG. 4, the second line latch signal TP2 shows the same waveform as that of the first line latch signal TP1 from the timing controller 110 after the delay time caused by the delay circuit 320 has elapsed.

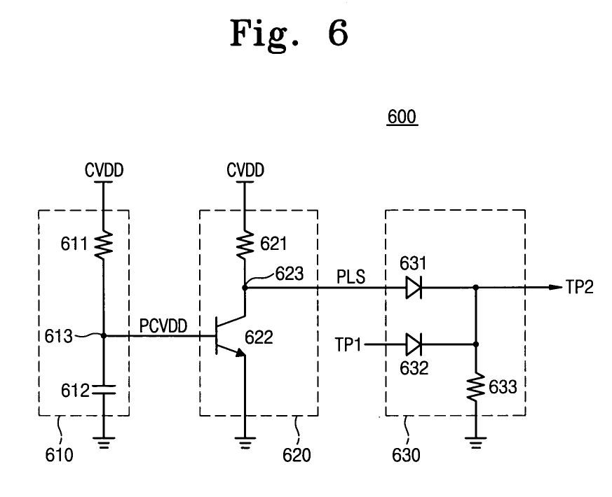

FIG. 6 is a circuit diagram showing a control circuit 600 according to another exemplary embodiment of the present invention.

Referring to FIG. 6, a control circuit 600 includes a delay circuit 610, a pulse generating circuit 620 and an output circuit 630. The delay circuit 600 includes a first resistor 611 connected between an external power voltage CVDD and node 613, and further includes a capacitor 612 connected to node 613 and ground. The voltage at node 613 is referred to as PCVDD in FIG. 6. The pulse generating circuit 620 includes a second resistor 621 having a first terminal to which the external power voltage CVDD is applied. The second terminal of second resistor 621 and a first terminal of transistor 622 are connected via a node 623. The second terminal of transistor 622 is connected to ground, while the gate of transistor 622 is connected to node 613.

The output circuit 630 includes a first diode 631 having an input terminal connected to a node 623 between the second resistor 621 and the transistor 622, and an output terminal from which the second line latch signal TP2 is output. The voltage at node 623 is referred to as PLS in FIG. 6. Output circuit 630 further includes a second diode 632 having an input terminal to which the first line latch signal TP1 is applied and an output terminal commonly connected with the output terminal of the first diode 631 and a third resistor 633. Third resistor 633 is connected between the output terminals of the first and second diodes 631 and 632 and ground. The second line latch signal TP2 is output from the output terminals of the first and second diodes 631 and 632.

Hereinafter, an operation of the control unit shown in FIG. 6 will be described in detail.

After the external power voltage CVDD is applied to the liquid crystal display 100, the external power voltage CVDD is output as the second line latch signal TP2 via the second resistor 621 and the first diode 631 while the transistor 622 is turned off. The voltage at the gate of transistor 622, PCVDD, changes from its initial value to a voltage substantially equal to CVDD after a time dependent on the resistance of first resistor 611 and the capacitance of capacitor 612 has elapsed. When the transistor 622 is turned on by the first resistor 611 and the capacitor 612 after a predetermined time (also dependent on the resistance of first resistor 611 and the capacitance of capacitor 612), the voltage at node 623, PLS, approaches ground, and diode 631 is turned off. Subsequently, the first line latch signal TP1 from the timing controller 110 is output through the output terminal of the second diode 632 (i.e., signal TP1 turns diode 632 off and on, depending on its value). Thus, when the pre-determined time caused by the first resistor 611 and the capacitor 612 (the delay time) has elapsed after the power is turned on, the second line latch signal TP2 has the same waveform as that of the first line latch signal TP1 from the timing controller 110.

According to the above, the line latch signal that controls the latch in the data driving circuit is set at the high level before the data driving voltages are applied to the data driving circuit when a power-on state of the display is initiated. Thus, although the data driving voltages are applied to the data driving circuit, the latch does not output the data signals. As a result, the liquid crystal display may prevent the display of the error-images on the liquid crystal panel, since the data lines are not driven until a pre-determined time has elapsed, where the pre-determined time is about equal to or greater than a time for the gate-off voltage to be lowered to a level sufficient to turn off the thin film transistor.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A flat panel display comprising:
a timing controller configured to output an image data signal;
a data driver configured to drive a data line in response to a control signal and the image data signal; and
a control circuit to generate the control signal, wherein the control signal is indicative of a power state of the display, and wherein the data driver is configured to drive the data line in a reset state for a predetermined time subsequent to the control signal indicating the initiation of a power-on state of the display.

2. The flat panel display of claim 1, wherein the timing controller is further configured to output a line latch signal to indicate a drive timing of the data line by the data driver.

3. The flat panel display of claim 2, wherein the control circuit is configured to receive an external power voltage and the line latch signal, and wherein the control signal has a same waveform as that of the line latch signal subsequent to the predetermined time.

4. The flat panel display of claim 2, wherein the control circuit further comprises:
a delay circuit configured to delay an external power voltage to transmit a delayed external power voltage;
a pulse generator configured to receive the external power voltage and the delayed external power voltage from the delay circuit and further configured to generate a pulse signal; and
a logic circuit configured to output the control signal based on the line latch signal and the pulse signal.

5. The flat panel display of claim 1, further comprising:
a display pixel including a transistor including a gate, the transistor configured to be in an on state in response to a sufficient gate-on voltage applied to the gate, and wherein the transistor is further configured to be in an off state in response to a sufficient gate-off voltage applied to the gate; and
a gate driver configured to drive a gate line in communication with the gate, and wherein the pre-determined time is selected to be about equal to or greater than a time between the initiation of the power-on state and a time for the gate driver to drive the gate using a sufficient gate-off voltage.

6. A flat panel display comprising:
a timing controller configured to output a first line latch signal and an image data signal;
a data driver configured to drive a data line in response to a second line latch signal and the image data signal; and
a control circuit configured to receive the first line latch signal and further configured to receive an external power voltage subsequent to a power-on of the display, the control circuit further configured to generate the second line latch signal, wherein the display is configured to maintain the data line in a reset state for a predetermined time subsequent to the power-on of the display.

7. The flat panel display of claim 6, wherein the control circuit further comprises:
a delay circuit configured to delay the external power voltage and to transmit a delayed external power voltage;
a pulse generator configured to receive the external power voltage and the delayed external power voltage and to generate a pulse signal; and
a logic circuit configured to output the second line latch signal based on the first line latch signal and the pulse signal.

8. The flat panel display of claim 6, wherein the data driver comprises:
a latch circuit configured to latch the image data signal from the timing controller in response to the second line latch signal; and
an output driving circuit configured to receive the image data signal from the latch circuit and to drive the data line in response to the second line latch signal.

9. The flat panel display of claim 8, wherein the control circuit is configured to output the second line latch signal such that an output of the latch circuit is maintained in the reset state for the predetermined time subsequent to the power-on of the display.

10. A flat panel display comprising:
a display panel having a data line, a gate line and a pixel electrically connected to the data line and the gate line;
a timing controller configured to output control signals and an image data signal;
a data driver configured to drive the data line in response to a portion of the control signals and the image data signal;
a gate driver configured to drive the gate line in response to a different portion of the control signals; and
a control circuit configured to control the data driver to allow the data line not to be driven with the image data signal for a predetermined time after initiation of a power-on state of the display.

11. The flat panel display of claim 10, wherein the control signals from the timing controller comprise a first line latch signal indicative of timing to apply the image data signal to the data line.

12. The flat panel display of claim 10, wherein the control circuit is configured to output a second line latch signal to control the data driver.

13. The flat panel display of claim 10, wherein the control circuit is configured to output a second line latch signal having a predetermined level for the predetermined time after the initiation of the power-on state of the display.

14. The flat panel display of claim 13, wherein the control circuit is configured to output a first line latch signal from the timing controller as the second line latch signal after the predetermined time after the initiation of the power-on state of the display has elapsed.

15. The flat panel display of claim 14, wherein the control circuit comprises:
a delay circuit configured to delay an external power voltage and to transmit a delayed external power voltage;
a pulse generator configured to receive the external power voltage and the delayed external power voltage from the delay circuit and to generate a pulse signal; and
a logic circuit configured to receive the pulse signal from the pulse generator and the first line latch signal from the timing controller and to output the second line latch signal.

16. The flat panel display of claim 15, wherein the logic circuit comprises an OR gate.

17. The flat panel display of claim 16, wherein the control circuit comprises:
a first resistor having a first terminal configured to receive the external power voltage;
a capacitor electrically connected between a second terminal of the first resistor and a ground;
a second resistor having a first terminal configured to receive the external power voltage;
a transistor having a gate electrically connected to the second terminal of the first resistor and a current path electrically connected between a second terminal of the second resistor and the ground;
a first diode having an input terminal electrically connected to the second terminal of the second resistor and an output terminal; and
a second diode having an input terminal configured to receive the first line latch signal from the timing controller and an output terminal,
wherein the output terminals of the first and second diodes are commonly connected to each other, and the control circuit is configured such that, in operation, the second line latch signal is output from the output terminals of the first and second diodes.

18. The flat panel display of claim 11, wherein the data driver comprises:
a shift register configured to shift a clock signal in response to a horizontal start signal;
a data register configured to store the image data signal from the timing controller in response to the clock signal from the shift register;
a latch configured to latch the stored image data signal in the data register in response to the second line latch signal from the control circuit;
a digital-to-analog converter configured to convert the image data signal from the latch into an analog image signal; and
an output buffer configured to output the analog image signal from the digital-to-analog converter to the data line in response to the first line latch signal.

19. A method of driving a flat panel display having a data driver driving a data line in response to an image data signal, the method comprising:
turning on a power to the display; and
resetting the data driver for a predetermined time.

20. The method of claim 19, wherein the predetermined time is a time between turning on the power to the display and a time at which the gate line is driven to a sufficient gate-off voltage to turn off one or more transistors connected to the gate line.

21. A method of driving a flat panel display having a data driver driving a data line in response to an image data signal, the method comprising:
applying a power voltage;
delaying the power voltage;
generating a pulse signal in response to the power voltage and the delayed power voltage, the pulse signal having a pulse width of a pre-determined time; and
providing the data driver with the pulse signal to reset the data line for the pre-determined time.

22. The method of claim 21, wherein the pulse signal is a line latch signal.
